(19) United States
(12) Patent Application Publication
(10) Pub. No.: US 2025/0206584 A1
(43) Pub. Date: Jun. 26, 2025

(54) JACKING DEVICE

(71) Applicant: Changshu Tongrun Auto Accessory Co., Ltd., Suzhou (CN)

(72) Inventors: Weijia SHAO, Suzhou (CN); Jiawei DING, Suzhou (CN); Dingchun LIANG, Suzhou (CN)

(21) Appl. No.: 18/752,437

(22) Filed: Jun. 24, 2024

(30) Foreign Application Priority Data
Dec. 25, 2023 (CN) 202311795334.8

(51) Int. Cl. B66F 3/30; B66F 3/24

(52) U.S. Cl. CPC B66F 3/30; B66F 3/247

(57) ABSTRACT

The present disclosure relates to a jacking device. A device base provided with a jacking channel. The jacking channel extends in a longitudinal direction of the device base. A jacking body member is movably mounted inside the jacking channel in the longitudinal direction of the device base. A jacking power member is disposed on the device base. The jacking power member is drivingly connected to the jacking body member and configured to apply jacking driving force to the jacking body member. The jacking driving force is configured to drive the jacking body member to move upward along the jacking channel. A locking mechanism is disposed on one of the device base and the jacking body member. The locking mechanism is configured to lock the jacking body member in any position of the jacking channel.

### CROSS-REFERENCE TO RELATED APPLICATIONS

This application claims priority to Chinese patent application No. 2023117953348, filed on Dec. 25, 2023, and the content of which is hereby incorporated by reference in its entirety.

### TECHNICAL FIELD

The present disclosure relates to the field of jacking technologies, and in particular, to a jacking device.

### BACKGROUND

Jacking devices refer to light and small lifting devices that use rigid jacking members as working devices to lift load-bearing components. The jacking devices are mainly applied in factories and mines, transportation and other scenarios for vehicle repair and other lifting and supporting work. The jacking device is light, strong, flexible, and reliable, and can be carried and operated by one person. Conventional jacking devices are generally locked by the mutual engagement of the locking teeth and engaging tabs on the rigid jacking members.

However, it cannot ensure that the racks and the engaging tabs of the rigid jacking members are completely engaged during use, and thus the stability of the jacking device is compromised, which become an urgent technical problem that those skilled in the art need to solve.

### SUMMARY

Accordingly, it is necessary to provide a jacking device to address the technical problems as mentioned above.

The present disclosure provides a jacking device, which includes: a device base provided with a jacking channel, the jacking channel extending in a longitudinal direction of the device base, where a positioning base plate, at least two positioning support plates, and a plurality of positioning support portions are disposed at a bottom of the device base, the at least two positioning support plates are symmetrically fixed at a bottom of each positioning support portion, and the positioning base plate is fixedly connected to the at least two positioning support plates; a jacking body member movably mounted inside the jacking channel in the longitudinal direction of the device base, and the jacking body member being provided with a plurality of locking bodies; a jacking power member disposed on the device base, the jacking power member being drivingly connected to the jacking body member and configured to apply jacking driving force to the jacking body member, the jacking driving force being configured to drive the jacking body member to move upward along the jacking channel; a locking mechanism disposed on an upper portion of the device base, the locking mechanism including a first locking element and a second locking element, where the device base is provided with a locking through hole, the second locking element is configured to be movably mounted in the locking through hole, where the second locking element is capable of being in locked contact with any one of the locking bodies in the locking through hole, so that the jacking body member is locked in any position of the jacking channel, where the first locking element is rotatably mounted on the device base, the first locking element includes a locking end configured to be in a locked contact with the respective locking body; and an elastic driving element mounted on the device base, the elastic driving element being elastically and drivingly connected to the first locking element and being configured to drive the locking end of the first locking element to move toward the respective locking body.

In an embodiment, the plurality of locking bodies are linearly distributed in a length direction of the jacking body member.

In an embodiment, each locking body includes a locking tooth portion. A plurality of locking tooth portions are continuously distributed in the length direction of the jacking body member.

In an embodiment, the jacking body member and the locking body are integrally formed.

In an embodiment, the second locking element is connected to the device base through a connecting element.

In an embodiment, the second locking element is provided with an engaging tooth portion configured to be engaged and locked with the locking tooth portion.

In an embodiment, he locking mechanism further includes: a holding element fixedly connected to the first locking element.

In an embodiment, the locking mechanism further includes a rotating shaft. The device base is provided with a first shaft hole; the first locking element is provided with a second shaft hole; the rotating shaft is mounted in the first shaft hole and the second shaft hole. The elastic driving element includes a torsion spring. The torsion spring is sleeved on the rotating shaft. A first end of the torsion spring is in contact with the device base, and a second end of the torsion spring is in contact with the first locking element. The torsion spring is configured to drive the locking end of the first locking element to move toward the respective locking body.

In an embodiment, the device base is provided with a first limiting portion, the first locking element is provided with a second limiting portion. The first end of the torsion spring is in limited contact with the first limiting portion of the device base; and the second end of the torsion spring is in limited contact with the second limiting portion of the first locking element.

In an embodiment, the rotating shaft is provided with a first locking pin hole; the first locking element is provided with a second locking pin hole; and a locking pin is disposed in the first locking pin hole and the second locking pin hole.

In an embodiment, a top end of the jacking body member is provided with a jacking base body.

In an embodiment, a power channel is defined in the jacking body member. The power channel extends in a length direction of the jacking body member. The jacking power member is fixedly mounted in the power channel of the jacking body member.

In an embodiment, the positioning base plate is provided with a base positioning portion, a bottom of the jacking power member is positioned and assembled with the base positioning portion of the positioning base plate.

In an embodiment, the jacking power member includes a gas spring.

In an embodiment, the base positioning portion includes a positioning through hole defined on the positioning base plate.

### BRIEF DESCRIPTION OF THE DRAWINGS

FIG. 1 is a front view of a jacking device according to an embodiment of the present disclosure.

FIG. 2 is a side view of the jacking device according to an embodiment of the present disclosure.

FIG. 3 is a first cross-sectional view of a jacking device according to an embodiment of the present disclosure.

FIG. 4 is a second cross-sectional view of a jacking device according to an embodiment of the present disclosure.

FIG. 5 is a third cross-sectional view of a jacking device according to an embodiment of the present disclosure.

FIG. 6 is a partial cross-sectional view of a jacking device according to an embodiment of the present disclosure.

FIG. 7 is a first bottom view of a jacking device according to an embodiment of the present disclosure.

FIG. 8 is a second bottom view of a jacking device according to an embodiment of the present disclosure.

### ILLUSTRATION FOR REFERENCE NUMERALS

1000, device base; 2000, jacking body member; 3000, locking mechanism;
1000a, jacking channel; 1000b, locking through hole; 1100, positioning support portion; 1200, positioning base plate; 1100a, positioning support plate; 1200a, base positioning portion;
1200a1, positioning gasket; 1200a2, positioning pin;
2000a, jacking power member; 2000b, power channel; 2100, locking body; 2200, jacking base body;
3100, second locking element; 3200, first locking element;
3100a, engaging tooth portion; 3100b, connecting element;
3210, locking end; 3220, elastic driving element; 3230, holding element; 3240, rotating shaft;
3250, first limiting portion; 3260, second limiting portion;
3240a, first locking pin hole; 3200a, second locking pin hole.

### DETAILED DESCRIPTION

In order to make the above objects, features and advantages of the present disclosure more obvious and easy to understand, the specific implementations of the present disclosure will be described in detail below with reference to the accompanying drawings. In the following description, numerous specific details are set forth in order to provide a thorough understanding of the present disclosure. However, the present disclosure can be implemented in many other ways different from those described herein. Those skilled in the art can make similar improvements without violating the connotation of the present disclosure. Therefore, the present disclosure is not limited by the specific embodiments disclosed below.

In the description of this disclosure, it should be understood that orientations or

positional relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, “circumferential” and etc. are based on the orientations or positional relationships shown in the drawings, only for the convenience of describing the present disclosure and simplifying the description, and not indicating or implying the device or element indicated must have a specific orientation, be constructed and operate in a specific orientation, and therefore which are not to be construed as limitations of the present disclosure.

In addition, if terms “first” and “second” appear, the terms “first” and “second” are used for descriptive purposes only and cannot be understood as indicating or implying relative importance or implicitly indicating the quantity of indicated technical features. Therefore, features defined by “first” or “second” may explicitly or implicitly include at least one of these features. In the description of the present disclosure, “plurality” means at least two, such as two, three, etc., unless otherwise expressly and specifically limited.

In this disclosure, unless otherwise clearly defined and limited, the terms “mounting”, “coupling”, “connection”, “fixation” and others should be understood in a broad sense, for example, which can be a fixed connection or a detachable connection, or integrally formed; or can be a mechanical connection or an electrical connection; or can be a direct connection or an indirect connection through an intermediate medium; or can be an internal connection between two elements or an interaction between two elements, unless otherwise specified defined. For those of ordinary skill in the art, the specific meanings of the above terms in the present disclosure can be understood according to specific circumstances.

In this disclosure, unless otherwise expressly stated and limited, a first feature being “on” or “below” a second feature may mean that the first feature is in direct contact with the second feature, or the first feature is in undirect contact with the second feature through an intermediate medium. Furthermore, a first feature being “over”, “above” and “on” a second feature may mean that the first feature is directly above or obliquely above the second feature, or simply means that the first feature is higher in level than the second feature. A first feature being “below”, “under” and “beneath” a second feature may mean that the first feature is directly below or obliquely below the second feature, or simply means that the first feature is lower in level than the second feature.

It should be noted that when an element is referred to as being “fixed to” or “disposed on” another element, it can be directly on the other element or an intermediate element may also be present. When an element is referred to as being “connected” to another element, it can be directly connected to the other element or there may also be an intermediate element. The term “vertical”, “horizontal”, “upper”, “lower”, “left”, “right” or similar expressions used herein, if exits, is for illustrative purposes only and do not represent the unique implementations.

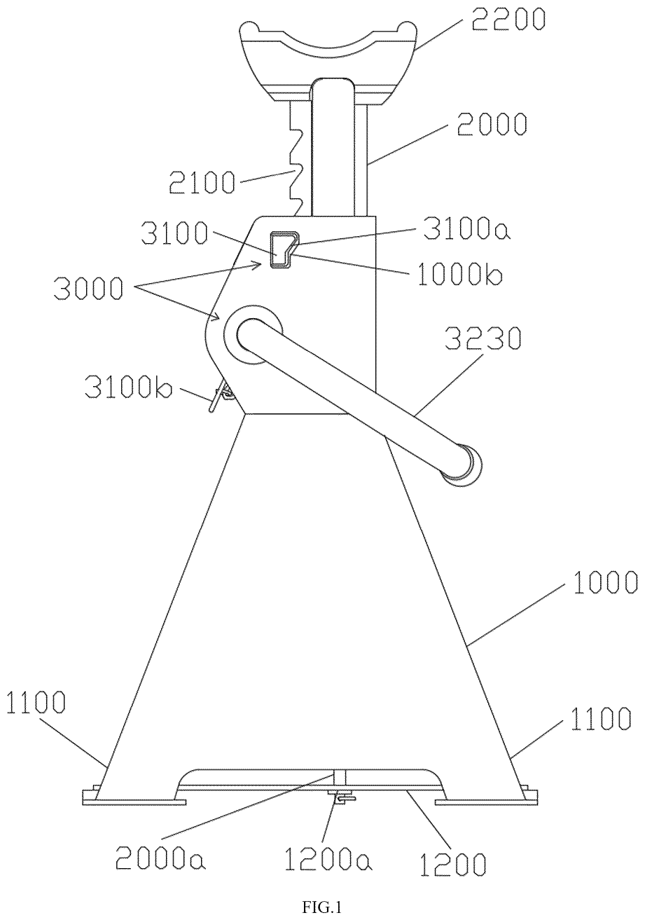

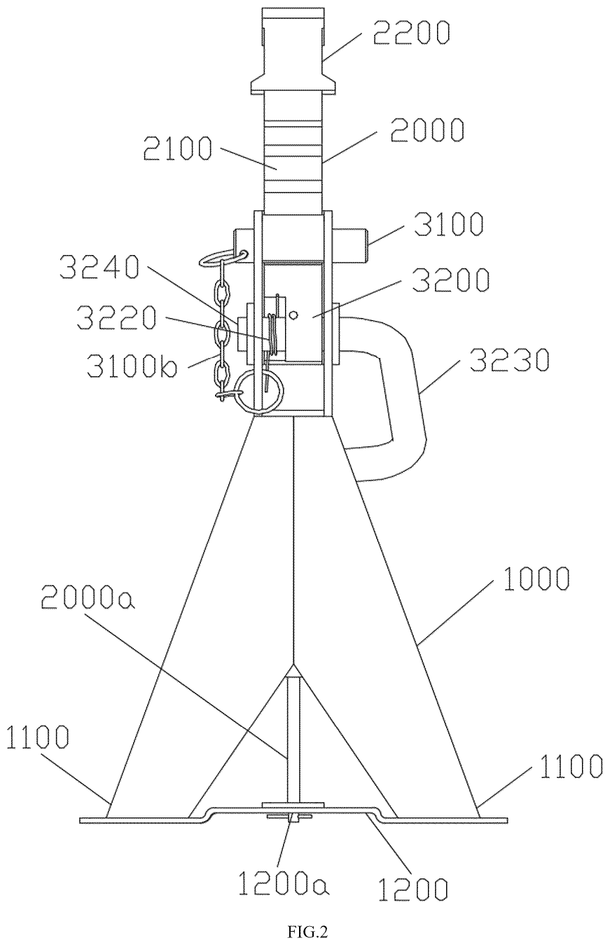

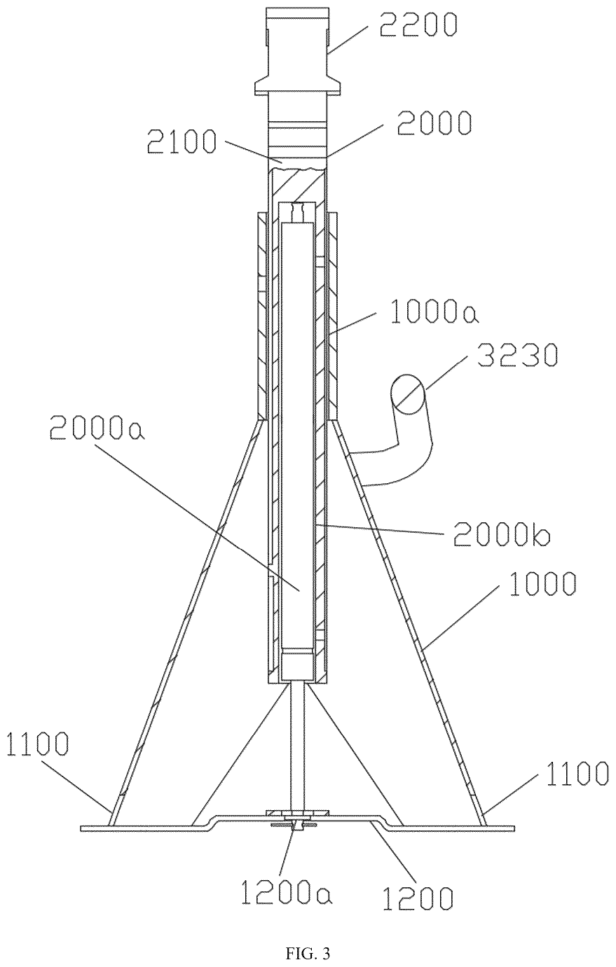

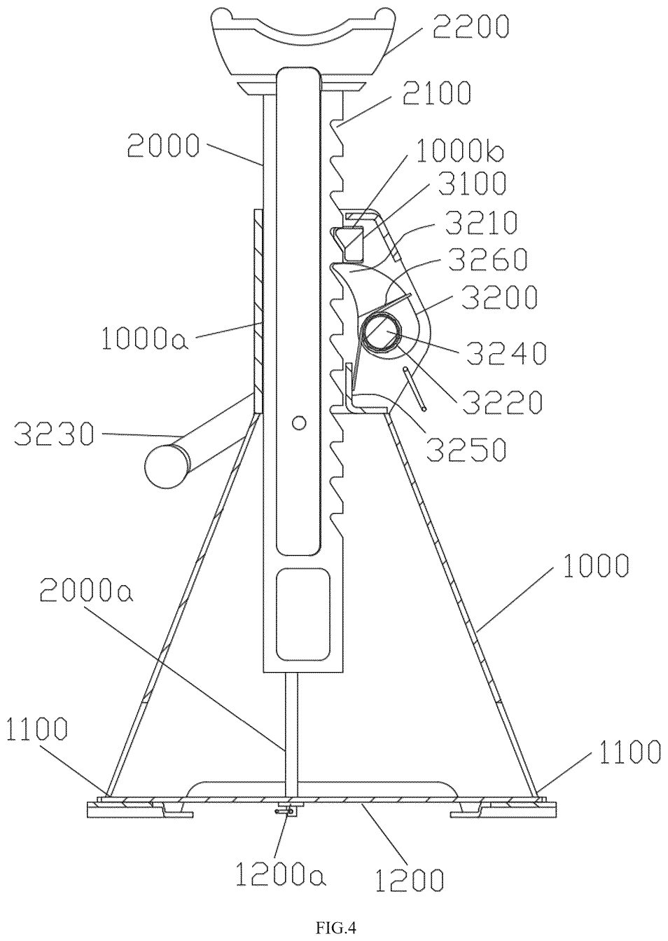

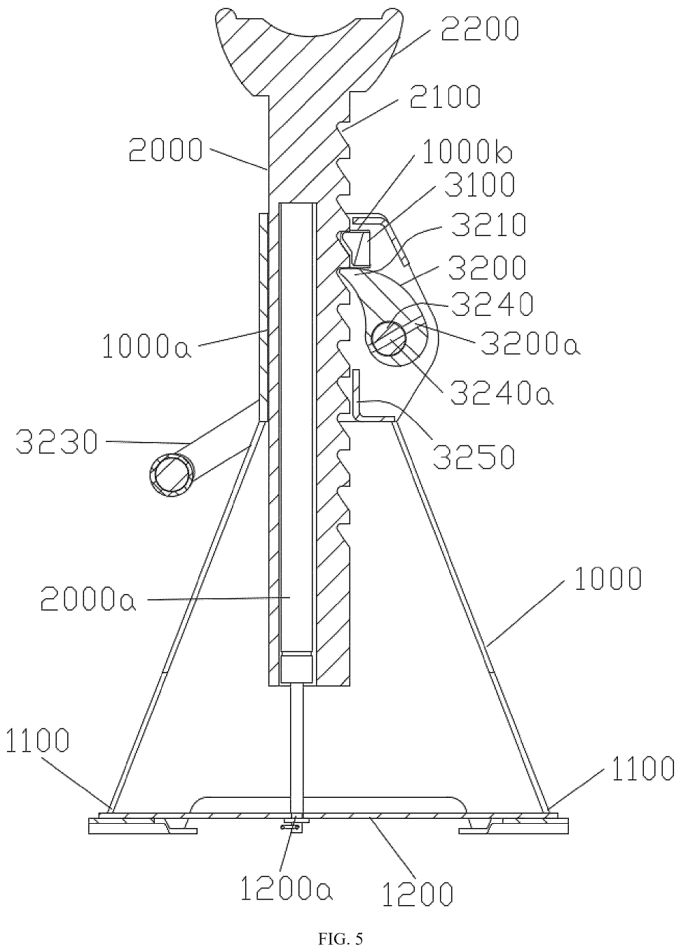

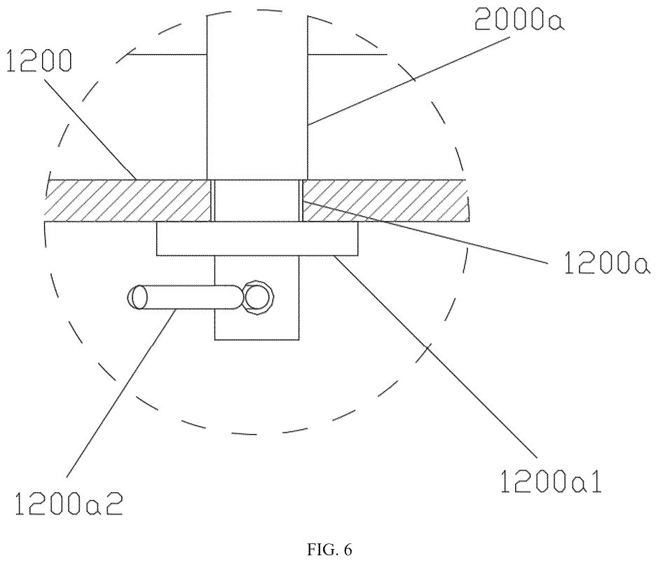

As shown in FIGS. 1 to 8, an embodiment of the present disclosure provides a jacking device. The jacking device includes a device base 1000, a jacking body member 2000, a jacking power member 2000a, a locking mechanism 3000 and other components. The device base 1000 is an assembly basis for the jacking body member 2000, the jacking power member 2000a, the locking mechanism 3000 and other components. The form of the device base 1000 is not limited thereto. For example, the device base 1000 can include a base with holes, or a base structure composed of four angle irons. The device base 1000 is provided with a jacking channel 1000a. The jacking channel 1000a extends in a longitudinal direction of the device base 1000. The jacking body member 2000 can be movably mounted inside the jacking channel 1000a in the longitudinal direction of the device base 1000. The jacking body member 2000 is a component that provides a jacking function. The jacking body member 2000 can have a structure of a straight-line body, such as a columnar body, a rod-shaped body, a plate-shaped body, or others. The jacking channel 1000a can be configured according to the jacking body member 2000. The jacking channel 1000a is constructed to be adapted to the jacking body member 2000, so that the jacking body member 2000 can be adaptively accommodated inside the jacking channel 1000a. Moreover, as a component that provides a jacking function, the jacking body member 2000 needs to have a certain strength. The top end of the jacking body member 2000 can be provided with a jacking base body 2200. The jacking base body 2200 can include a contact region adapted to a profile of the load-bearing component, for example, a contact depression and the like in a shape adapted to a profile of the load-bearing component. The contact between the jacking base body 2200 and the load-bearing component can increase the contact area therebetween, and disperse the contact stress.

The jacking power member 2000a is disposed on the device base 1000. The jacking power member 2000a can be drivingly connected to the jacking body member 2000. The jacking power member 2000a can include a component such as a gas spring or a hydraulic rod, that can apply jacking driving force. In an embodiment, a power channel 2000b can be defined in the jacking body member 2000. The power channel 2000b extends in a length direction of the jacking body member 2000, and is thus indirectly mounted to the device base through the jacking body member 2000. The jacking power member 2000a is fixedly mounted in the power channel 2000b of the jacking body member 2000. When the jacking power member 2000a performs a jacking movement, the jacking power member 2000a can apply a force to the device base 1000 or a plane (table surface, ground surface, etc.) on which the device base 1000 is installed. Meanwhile, the reaction force applied by the device base 1000 or the plane on which the device base 1000 is installed to the jacking power member 2000a can be transmitted to the jacking body member 2000, which also means that the jacking power member 2000a applies a jacking driving force to the jacking body member 2000. The jacking power member 2000a is configured to apply a jacking driving force to the jacking body member 2000. Under the lifting driving force, the jacking body member 2000 can be driven to move upward along the jacking channel 1000a until it contacts the load-bearing component.

A positioning base plate 1200 can be disposed at the bottom of the device base 1000. The positioning base plate 1200 is provided with a base positioning portion 1200a. The bottom of the jacking power member 2000a can be positioned and assembled with the base positioning portion 1200a of the positioning base plate 1200, so that the jacking power member 2000a can apply force to the positioning base plate 1200 of the device base 1000. In addition, while the jacking power member 2000a applies force, the positioning assembly between the base positioning portion 1200a and the bottom of the jacking power member 2000a can ensure stability the movement of the jacking power member 2000a. The base positioning portion 1200a may include, for example, a positioning through hole or a positioning groove defined on the positioning base plate 1200. For example, when the base positioning portion 1200a includes a positioning through hole defined on the positioning base plate 1200, the bottom of the jacking power member 2000a can extend into the positioning through hole. In this case, a positioning gasket 1200a1 can be disposed on the side of the positioning through hole away from the jacking power member 2000a to disperse the stress. A positioning pin 1200a2 is inserted into the corresponding hole structure at the bottom of the jacking power member 2000a, so that the bottom of the jacking power member 2000a can be fixedly mounted in the positioning through hole.

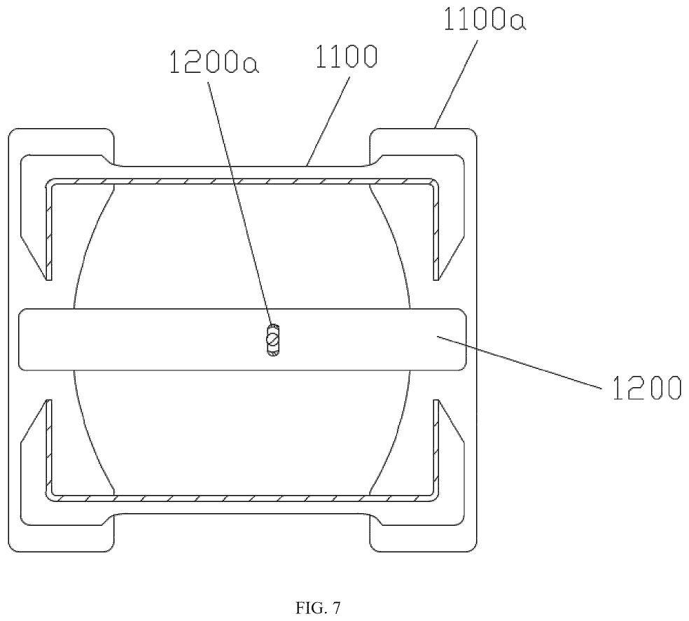

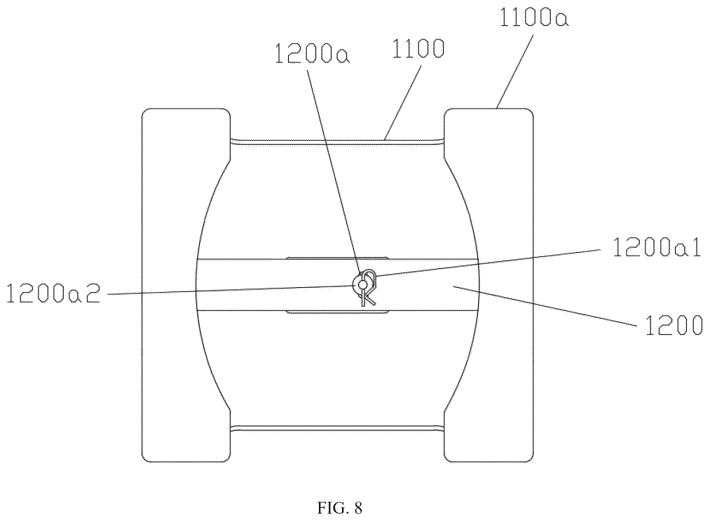

In an embodiment, a plurality of positioning support portions 1100 may be disposed at the bottom of the device base 1000. The positioning base plate 1200 may be fixedly connected to the plurality of positioning support portions 1100 to ensure the stability of the bottom support. A positioning support plate 1100a may be disposed at the bottom of the positioning support portion 1100. As shown in FIGS. 7 and 8, the positioning base plate 1200 can be connected to the positioning support plate 1100a. The mutual connection between the positioning base plate 1200 and the positioning support plate 1100a can improve the structural stability of the device base 1000. In an embodiment, four positioning support portions 1100 may be disposed at the bottom of the device base 1000. The four positioning support portions 1100 may be symmetrically disposed at four corners of the device base 1000. In this case, two positioning support plates 1100a may be provided. Each positioning support plate 1100a connects two adjacent positioning support portions 1100, so that the four positioning support portions 1100 are fixedly connected through the two positioning support plates 1100a. The two positioning support plates 1100a are elongated. The two positioning support plates 1100a are disposed symmetrically and parallel to each other. The positioning base plate 1200 is fixedly connected to the two positioning support plates 1100a at the same time. The positioning base plate 1200 and the two positioning support plates 1100a are perpendicular to each other.

The jacking power member 2000a can have a structure, such as a columnar body, a rod-shaped body or a plate-shaped body that is linearly shaped. The power channel 2000b can be constructed to be adapted to the structure of the jacking power member 2000a, so that the jacking power member 2000a can be adaptably received inside the power channel 2000b. In addition, the jacking power member 2000a can also be directly disposed on the device base 1000. The jacking power member 2000a applies force to the device base 1000 or the plane (table surface, ground surface, etc.) on which the device base 1000 is installed. Meanwhile, the reaction force applied by the device base 1000 or the plane on which the device base 1000 is installed to the jacking power member 2000a can be transmitted to the jacking body member 2000, as such, the jacking power member 2000a applies a jacking driving force to the jacking body member 2000. Those skilled in the art can arrange the assembly relationship and structural form between the device base 1000, the jacking body member 2000 and the jacking power member according to actual needs, which are not limited herein.

The locking mechanism 3000 is disposed on at least one of the device base 1000 and the jacking body member 2000. For example, the locking mechanism 3000 is disposed on the device base 1000, for a locking cooperation with the jacking body member 2000. Alternatively, the locking mechanism 3000 is disposed on the jacking body member 2000, for a locking cooperation with the device base 1000. Alternatively, the locking mechanism 3000 includes a plurality of components. The plurality of components are respectively disposed on the device base 1000 and the jacking body member 2000, so that the locking mechanism 3000 can lock the jacking body member 2000 in the jacking channel 1000a at any position as required.

Therefore, although the jacking power member 2000a applies the jacking driving force to the jacking body member 2000, when the locking mechanism 3000 locks the jacking body member 2000 relative to the device base 1000, the jacking body member 2000 can remain stationary relative to the device base 1000. When the locking mechanism 3000 unlocks the jacking body member 2000 relative to the device base 1000, the jacking driving force applied by the jacking power member 2000a will drive the jacking body member 2000 to move upward along the jacking channel 1000a until it reaches the load-bearing component.

When the jacking body member 2000 moves upward to the load-bearing component along the jacking channel 1000a, the locking mechanism 3000 can lock the jacking body member 2000 relative to the device base 1000 again. The jacking body member 2000 remains jacking the load-bearing component based on the jacking driving force, and the locking mechanism 3000 locks the jacking body member 2000 relative to the device base 1000, which also ensures that the jacking body member 2000 does not move longitudinally randomly, ensuring the stability and safety during jacking.

In an embodiment, the locking mechanism 3000 may include a second locking element 3100. The device base 1000 is provided with a locking through hole 1000b. The second locking element 3100 is configured to be movably mounted in the locking through hole 1000b. The jacking body member 2000 is provided with a plurality of locking bodies 2100. The plurality of locking bodies 2100 are linearly distributed in the length direction of the jacking body member 2000. Therefore, each locking body 2100 can establish a locked position on the jacking body member 2000.

When the second locking element 3100 is not mounted in the locking through hole 1000b, the second locking element 3100 cannot form any cooperative relationship with the locking body 2100, so the jacking body member 2000 can move upward to the load-bearing component along the jacking channel 1000a. During this movement, the jacking body member 2000 can jack the load-bearing component based on the jacking driving force applied by the jacking power member 2000a. Therefore, in this case, the jacking effect on the load-bearing component is achieved based only on the jacking driving force, which is realized by a conventional single jacking action.

After the second locking element 3100 is mounted in the locking through hole 1000b, the second locking element 3100 can cooperate with the locking body 2100. As the jacking body member 2000 moves inside the jacking channel 1000a, when the position of the jacking body member 2000 in the jacking channel 1000a is determined, the second locking element 3100 can cooperate with one of the locking bodies 2100 corresponding to the current jacking body member 2000, so that the jacking body member 2000 can be locked in any position of the jacking channel 1000a based on the mutual cooperation between the second locking element 3100 and the respective locking body 2100.

In this case, the locking cooperation between the second locking element 3100 and the respective locking body 2100 can provide a second jacking function. Rather than actively applying a jacking driving force to the jacking body member 2000 similar to that applied by the jacking power member 2000a, this jacking function is realized by the locking cooperation between the second locking element 3100 and the respective locking body 2100 when the load-bearing component applies downward pressure on the jacking body member 2000, based on the interaction of forces, which has a forced jacking effect.

Therefore, the above-mentioned components that cooperate with each other can jack the load-bearing component stably under the action of the jacking driving force applied by the jacking power member 2000a and the forced jacking effect generated between the second locking element 3100 and the locking body 2100.

The locking body 2100 can have various adapted structures such as teeth, grooves, holes, etc. For example, in an embodiment, the locking body 2100 includes a locking tooth portion. A plurality of locking tooth portion are continuously distributed in the length direction of the jacking body member 2000. The jacking body member 2000 and the locking body 2100 are integrally formed. The second locking element 3100 can be connected to the device base 1000 through various connecting elements 3100b such as connecting chains, connecting ropes, and connecting wires to facilitate the use of the second locking element 3100. In an embodiment, the second locking element 3100 may also be provided with an engaging tooth portion 3100a. The engaging tooth portion 3100a is configured to be engaged and locked with the locking tooth portion.

In an embodiment, the locking mechanism 3000 may further include a first locking element 3200 and an elastic driving element 3220. The first locking element 3200 is rotatably mounted on the device base 1000. The first locking element 3200 includes a locking end 3210. The locking end 3210 is configured to be in a locked contact with the locking body 2100. The elastic driving element 3220 is mounted on the device base 1000. The elastic driving element 3220 is elastically and drivingly connected to the first locking element 3200, and is configured to drive the locking end 3210 of the first locking element 3200 to move toward the locking body 2100. The first locking element 3200 can be rotatably mounted on the device base 1000 by means of a rotating shaft 3240, for example. The device base 1000 is provided with a first shaft hole. The first locking element 3200 is provided with a second shaft hole. The rotating shaft 3240 is mounted in the first shaft hole and the second shaft hole. The elastic driving element 3220 can be a torsion spring or other components that can apply elastic force. The torsion spring is sleeved on the rotating shaft. A first end of the torsion spring is in contact with the device base, and a second end of the torsion spring is in contact with the first locking element 3200. The torsion spring is configured to drive the locking end 3210 of the first locking element 3200 to move toward the locking body 2100.

In an embodiment, the device base is provided with a first limiting portion 3250, and the first locking element 3200 is provided with a second limiting portion 3260. The first end of the torsion spring is in limited contact with the first limiting portion 3250 of the device base. The second end of the torsion spring is in limited contact with the second limiting portion 3260 of the first locking element 3200. The first limiting portion 3250 may include a protrusion, a groove or other structures disposed on the device base, which can form a stable limited contact structure. The second limiting portion 3260 may also include a protrusion, a groove or other structures disposed on the first locking element 3200, which can form a stable limited contact structure. The rotating shaft is provided with a first locking pin hole 3240a, the first locking element 3200 is provided with a second locking pin hole 3200a. A locking pin is disposed in the first locking pin hole 3240a and the second locking pin hole 3200a. The locking mechanism 3000 further includes a holding element 3230. The first locking element 3200 can also be fixedly connected to a holding element 3230 to facilitate hand control. Those skilled in the art can configure the specific structures of the second locking element 3100 and the first locking element 3200 as well as the assembly relationship between the second locking element 3100, the first locking element 3200 and the device base 1000 according to actual needs, which are not limited herein.

When it is required to perform jacking, the first locking element 3200 can be lifted first. At this time, the jacking body member 2000 can automatically lift under the action of the jacking power member 2000a until it contacts the load-bearing component. The first locking element 3200 can automatically return to the state of engagement with the jacking body member 2000 under the action of the elastic driving element. Then, the second locking element 3100 is inserted to ensure the effectiveness of the first locking element 3200 and prevent safety accidents when the first locking element 3200 fails.

When it is required to finish jacking, the second locking element 3100 is pulled out, the first locking element 3200 is lifted up, and then the jacking body member 2000 can return to the lowest position under the action of external force.

In the above-mentioned jacking device, when the locking mechanism unlocks the jacking body member from the device base, the jacking driving force applied by the jacking power member can drive the jacking body member to move upward along the jacking channel until it reaches the load-bearing component. In this case, the locking mechanism locks the jacking body member relative to the device base again. The jacking body member remains jacking the load-bearing component based on the jacking driving force, and the locking mechanism locks the jacking body member with respect to the device base, which also ensures that the jacking body member does not move longitudinally randomly, ensuring the stability and safety during jacking.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various variants and improvements can be made without departing from the concept of the present disclosure, and all fall within the protection scope of the present disclosure. Therefore, the patent protection of the present disclosure shall be subjected to the appended claims.

What is claimed is:

1. A jacking device, comprising:
a device base provided with a jacking channel, the jacking channel extending in a longitudinal direction of the device base, wherein a positioning base plate, at least two positioning support plates, and a plurality of positioning support portions are disposed at a bottom of the device base, the at least two positioning support plates are symmetrically fixed at a bottom of each positioning support portion, and the positioning base plate is fixedly connected to the at least two positioning support plates;
a jacking body member movably mounted inside the jacking channel in the longitudinal direction of the device base, and the jacking body member being provided with a plurality of locking bodies;
a jacking power member disposed on the device base, the jacking power member being drivingly connected to the jacking body member and configured to apply jacking driving force to the jacking body member, the jacking driving force being configured to drive the jacking body member to move upward along the jacking channel;
a locking mechanism disposed on an upper portion of the device base, the locking mechanism comprising a first locking element and a second locking element, wherein the device base is provided with a locking through hole, the second locking element is configured to be movably mounted in the locking through hole, and the second locking element is capable of being in locked contact with any one of the locking bodies in the locking through hole, so that the jacking body member is locked in any position of the jacking channel, and wherein the first locking element is rotatably mounted on the device base, and the first locking element comprises a locking end configured to be in a locked contact with the respective locking body; and
an elastic driving element mounted on the device base, the elastic driving element being elastically and drivingly connected to the first locking element and being configured to drive the locking end of the first locking element to move toward the respective locking body.

2. The jacking device according to claim 1, wherein the plurality of locking bodies are linearly distributed in a length direction of the jacking body member.

3. The jacking device according to claim 2, wherein each locking body includes a locking tooth portion, and a plurality of locking tooth portions are continuously distributed in the length direction of the jacking body member.

4. The jacking device according to claim 2, wherein the jacking body member and the locking body are integrally formed.

5. The jacking device according to claim 2, wherein the second locking element is connected to the device base through a connecting element.

6. The jacking device according to claim 3, wherein the second locking element is provided with an engaging tooth portion configured to be engaged and locked with the locking tooth portion.

7. The jacking device according to claim 1, wherein the locking mechanism further comprises:
a holding element fixedly connected to the first locking element.

8. The jacking device according to claim 1, wherein the locking mechanism further comprises a rotating shaft;
wherein the device base is provided with a first shaft hole, the first locking element is provided with a second shaft hole, and the rotating shaft is mounted in the first shaft hole and the second shaft hole; and
wherein the elastic driving element includes a torsion spring, and wherein the torsion spring is sleeved on the rotating shaft; a first end of the torsion spring is in contact with the device base, and a second end of the torsion spring is in contact with the first locking element; and the torsion spring is configured to drive the locking end of the first locking element to move toward the respective locking body.

9. The jacking device according to claim 8, wherein the device base is provided with a first limiting portion, and the first locking element is provided with a second limiting portion; and
wherein the first end of the torsion spring is in limited contact with the first limiting portion of the device base, and the second end of the torsion spring is in limited contact with the second limiting portion of the first locking element.

10. The jacking device according to claim 8, wherein the rotating shaft is provided with a first locking pin hole; the first locking element is provided with a second locking pin hole; and
a locking pin is disposed in the first locking pin hole and the second locking pin hole.

11. The jacking device according to claim 1, wherein a top end of the jacking body member is provided with a jacking base body.

12. The jacking device according to claim 1, wherein a power channel is defined in the jacking body member; and wherein the power channel extends in a length direction of the jacking body member; and the jacking power member is fixedly mounted in the power channel of the jacking body member.

13. The jacking device according to claim 1, wherein the positioning base plate is provided with a base positioning portion, and a bottom of the jacking power member is positioned and assembled with the base positioning portion of the positioning base plate; and/or
wherein the jacking power member includes a gas spring.

14. The jacking device according to claim 13, wherein the base positioning portion includes a positioning through hole defined on the positioning base plate.
